(19) United States
(12) Patent Application Publication
(10) Pub. No.: US 2023/0134913 A1
(43) Pub. Date: May 4, 2023

(54) RECORDING APPARATUS

(71) Applicant: SEIKO EPSON CORPORATION, Tokyo (JP)

(72) Inventor: Yoshinori YANAGISAWA, Shiojiri-shi (JP)

(21) Appl. No.: 18/049,664

(22) Filed: Oct. 26, 2022

(30) Foreign Application Priority Data
Oct. 29, 2021 (JP) 2021-177188

(51) Int. Cl. B41J 29/02; B41J 11/00

(52) U.S. Cl. CPC B41J 29/02; B41J 11/007

(57) ABSTRACT

A gravity center position of a recording apparatus is on a side close to a second side plate with respect to an intermediate position between a first side plate and the second side plate. The number of components of a recording unit that are supported by the first side plate is smaller than the number of components thereof that are supported by the second side plate. The recording unit includes a transport belt configured to transport a medium, and the transport belt is stretched around a first pulley and a second pulley. When the transport path of the medium is viewed from a side, the components of the recording unit that are supported by the first side plate are positioned on the inner side of the transport belt.

The present application is based on, and claims priority from JP Application Serial Number 2021-177188, filed Oct. 29, 2021, the disclosure of which is hereby incorporated by reference herein in its entirety.

### BACKGROUND

### 1. Technical Field

The present disclosure relates to a recording apparatus that performs recording on a medium.

### 2. Related Art

In a printer being an example of a recording apparatus, when there are irregularities on a placement surface of the apparatus, a shape of a main body frame is deformed. With this, accuracy of positions of respective units mounted to the main body frame is degraded. In view of this problem, JP-A-2000-068657 discloses a printer that has a frame structure assembled separately from the main body frame and includes an imaging unit and a writing unit mounted to the frame structure. According to the printer, the imaging unit and the writing unit are provided to the frame structure that is assembled separately from the main body frame, and hence degradation of accuracy of the positions of the respective units, which is caused by distortion of the main body frame, can be suppressed.

According to the printer described in JP-A-2000-068657, distortion of the main body frame is less likely to affect the frame structure including the imaging unit and the writing unit. However, there is room for improvement with regard to the following matters.

The printer described in JP-A-2000-068657 has a configuration in which the frame structure including the imaging unit and the writing unit is placed on two upper stays constituting the main body frame. More specifically, the frame structure including the imaging unit and the writing unit is supported at two points for each upper stay, and hence is the frame structure is supported at four points in total. Thus, when distortion of the main body frame is caused, a gap is formed between the frame structure and the upper stay at any one of the four supporting points. With this, there may be a risk of distortion of the frame structure. However, such a problem is not considered in the above-mentioned printer described in JP-A-2000-068657.

Further, when the frame structure is distorted, there may be a risk of relative positional deviation between a sheet transport path provided to the main body frame and a sheet transport path in the frame structure or posture fluctuation. In such a case, there may be a risk that a sheet cannot appropriately be transported.

Here, it has been understood that distortion of the main body frame has a specific tendency depending on the gravity center position of the apparatus. Specifically, for example, in a case in which the gravity center position of the apparatus is close to the back surface of the apparatus, when a protruding portion is on the placement surface of the apparatus, the front surface of the apparatus tends to have a floating position regardless of a position of the apparatus with respect to the protruding portion. There is no support from the placement surface at the position floating from the placement surface of the apparatus, and hence the main body frame is distorted. When the gravity center position of the apparatus is not at the center, and is deviated in a predetermined direction as described above, the frame on a side opposite thereto is likely to be distorted. Therefore, it is preferred that measures to prevent deformation of the main body frame be taken in view of the above-mentioned matter.

### SUMMARY

In order to solve the above-mentioned problem, a recording apparatus according to the present disclosure includes a recording unit including a recorder configured to perform recording on a medium, and a first side plate and a second side plate being a pair of side plates positioned across the recording unit and being configured to support the recording unit, wherein an apparatus gravity center position is on a side close to the second side plate with respect to an intermediate position between the first side plate and the second side plate, the number of components of the recording unit that are supported by the first side plate is smaller than the number of components thereof that are supported by the second side plate, the recording unit includes a transport belt being a belt positioned at a position facing the recorder and being configured to transport the medium, the transport belt is stretched around a first pulley and a second pulley that are arranged along a transport direction of the medium, the components of the recording unit that are supported by the first side plate are positioned on an inner side of the transport belt when a transport path of the medium is viewed from a side, and the components of the recording unit that are supported by the second side plate are positioned on an inner side of an upstream extension region and an inner side of a downstream extension region when the transport path of the medium is viewed from a side, the upstream extension region being obtained by extending an inner region of the transport belt toward upstream of the transport path, the downstream extension region obtained by extending the inner region of the transport belt toward downstream of the transport path.

Further, a recording apparatus according to the present disclosure includes a recording unit including a recorder configured to perform recording on a medium, and a first side plate and a second side plate being a pair of side plates positioned across the recording unit and being configured to support the recording unit, wherein an apparatus gravity center position is on a side close to the second side plate with respect to an intermediate position between the first side plate and the second side plate, the number of components of the recording unit that are supported by the first side plate is smaller than the number of components thereof that are supported by the second side plate, the recording unit includes a supporting member being a member arranged at a position facing the recorder and being configured to support the medium, the components of the recording unit that are supported by the first side plate overlap with the supporting member when a transport path of the medium is viewed from a side, and the components of the recording unit that are supported by the second side plate are positioned on an inner side of an upstream extension region and an inner side of a downstream extension region when the transport path of the medium is viewed from a side, the upstream extension region being obtained by extending a region of the supporting member toward upstream of the transport path, the downstream extension region obtained by extending the region of the supporting member toward downstream of the transport path.

### BRIEF DESCRIPTION OF THE DRAWINGS

FIG. 1 is a view illustrating a medium transport path in a printer.

FIG. 2 is a view illustrating a positional relationship of a head unit, a cap carriage, and a wiper carriage.

FIG. 3 is a view schematically illustrating a relationship between a frame structure body and a motion unit.

FIG. 4 is a perspective view of the frame structure body on which the motion unit is mounted.

FIG. 5 is a perspective view of the frame structure body.

FIG. 6 is a perspective view of the frame structure body.

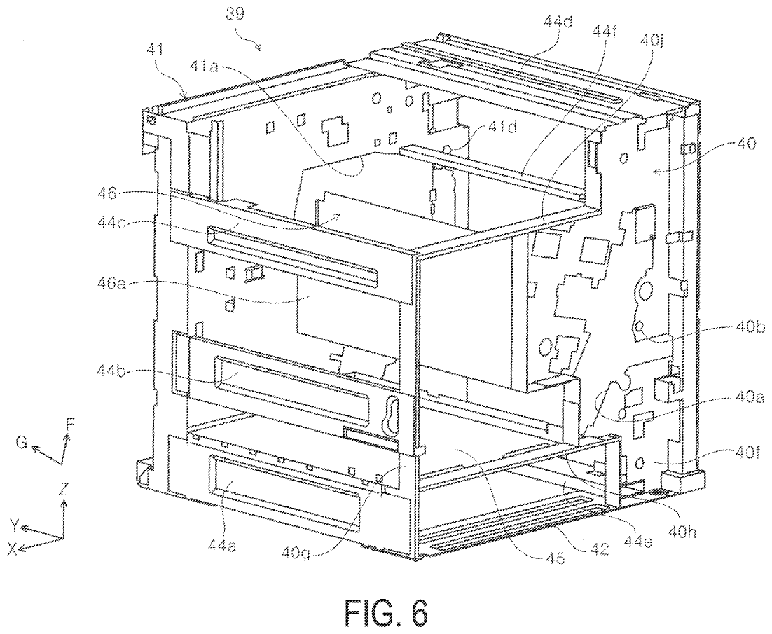

FIG. 7 is a perspective view of the motion unit.

FIG. 8 is a perspective view of the motion unit.

FIG. 9A and FIG. 9B illustrate a guide at the time of insertion of the motion unit into the frame structure body.

FIG. 10A, FIG. 10B, FIG. 10C, and FIG. 10D are views schematically illustrating a relationship between a position of a protruding portion on a placement surface with respect to a leg portion and a floating position of the leg portion.

FIG. 11A and FIG. 11B are views schematically illustrating deformation of a front frame.

FIG. 12 is a cross-sectional view of a part at which the motion unit and the front frame are coupled.

FIG. 13 is a view illustrating a positional relationship between a supported portion and a transport belt.

FIG. 14 is a view illustrating a medium transport path of a printer according to a second exemplary embodiment.

FIG. 15 is a view illustrating a positional relationship between a supported portion and a supporting member in the printer according to the second exemplary embodiment.

### DESCRIPTION OF EXEMPLARY EMBODIMENTS

The present disclosure is described below in schematic matter.

A recording apparatus according to a first aspect includes a recording unit including a recorder configured to perform recording on a medium, and a first side plate and a second side plate being a pair of side plates positioned across the recording unit and being configured to support the recording unit, wherein an apparatus gravity center position is on a side close to the second side plate with respect to an intermediate position between the first side plate and the second side plate, the number of components of the recording unit that are supported by the first side plate is smaller than the number of components thereof that are supported by the second side plate, the recording unit includes a transport belt being a belt positioned at a position facing the recorder and being configured to transport the medium, the transport belt is stretched around a first pulley and a second pulley that are arranged along a transport direction of the medium, the components of the recording unit that are supported by the first side plate are positioned on an inner side of the transport belt when a transport path of the medium is viewed from a side, and the components of the recording unit that are supported by the second side plate are positioned on an inner side of an upstream extension region and an inner side of a downstream extension region when the transport path of the medium is viewed from a side, the upstream extension region being obtained by extending an inner region of the transport belt toward upstream of the transport path, the downstream extension region obtained by extending the inner region of the transport belt toward downstream of the transport path.

According to this aspect, the apparatus gravity center position is on the side close to the second side plate with respect to the intermediate position between the first side plate and the second side plate. With this, when a protruding portion is present on the placement surface of the apparatus, distortion of the first side plate is likely to occur. Further, the number of components of the recording unit that are supported by the first side plate is smaller than the number of components thereof that are supported by the second side plate. Thus, distortion of the first side plate is less likely to affect the recording unit. With this, even when the first side plate is distorted, distortion of the recording unit can be suppressed, and hence position deviation of the transport belt from the pair of side plates and posture fluctuation can be suppressed. With this, the medium can be transported as appropriate.

Further, when a component of the recording unit that is supported by the first side plate (hereinafter, referred to as a “first component”) is displaced downward due to distortion of the first side plate, a component of the recording unit that is supported by the second side plate (hereinafter, referred to as a “second component”) is also displaced downward. In this case, when the first component and the second component are away from each other in a horizontal direction, twist deformation is likely to occur in the recording unit. Thus, a posture of the transport belt is likely to fluctuate with respect to the pair of side plates.

In addition, the recording unit has a risk that position deviation of the recording unit from the pair of side plates or posture fluctuation is more significant as a location where distortion occurs in the recording unit is farther away from the first component and the second component. Specifically, as the transport belt is at a location farther away from the first component and the second component, position deviation of the transport belt from the pair of side plates or posture fluctuation is likely to be increased.

Further, when position deviation of the transport belt from the pair of side plates or posture fluctuation occurs, relative position deviation between a medium transport mechanism, which is provided to the pair of side plates, and the transport belt or posture fluctuation occurs. Thus, there may be a risk that appropriate transport cannot be performed.

In view of this point, in this aspect, the first component is arranged on the inner side of the transport belt when the transport path of the medium is viewed from a side, and the second component is arranged on the inner side of the upstream extension region and the inner side of the downstream extension region when the transport path of the medium is viewed from a side, the upstream extension region being obtained by extending, toward upstream of the transport path, the inner region of the transport belt, the downstream extension region being obtained by extending, toward downstream of the transport path, the inner region of the transport belt.

With this, the second component is arranged across the first component. Thus, when the first component is displaced downward due to distortion of the first side plate, twist of the recording unit can be suppressed.

Further, the first component and the second component are arranged at positions close to the transport belt. Thus, position deviation of the transport belt from the pair of side plates or posture fluctuation at the time of occurrence of distortion in the recording unit can be suppressed.

With this, even when the first side plate is distorted, the medium can be transported as appropriate.

In addition, the recorder is positioned at a position facing the transport belt. Thus, position deviation of the recorder from the pair of side plates or posture fluctuation can also be suppressed.

A recording apparatus according to a second aspect includes a recording unit including a recorder configured to perform recording on a medium, and a first side plate and a second side plate being a pair of side plates positioned across the recording unit and being configured to support the recording unit, wherein an apparatus gravity center position is on a side close to the second side plate with respect to an intermediate position between the first side plate and the second side plate, the number of components of the recording unit that are supported by the first side plate is smaller than the number of components thereof that are supported by the second side plate, the recording unit includes a supporting member being a member arranged at a position facing the recorder and being configured to support the medium, the components of the recording unit that are supported by the first side plate overlap with the supporting member when a transport path of the medium is viewed from a side, and the components of the recording unit that are supported by the second side plate are positioned on an inner side of an upstream extension region and an inner side of a downstream extension region when the transport path of the medium is viewed from a side, the upstream extension region being obtained by extending a region of the supporting member toward upstream of the transport path, the downstream extension region obtained by extending the region of the supporting member toward downstream of the transport path.

In this aspect, similarly to the first aspect, the first component is positioned on the inner side of the supporting member when the transport path of the medium is viewed from a side, and the second component is positioned on the inner side of the upstream extension region and the inner side of the downstream extension region when the transport path of the medium is viewed from a side, the upstream extension region being obtained by extending, toward upstream of the transport path, the region of the supporting member, the downstream extension region being obtained by extending, toward downstream of the transport path, the inner region of the supporting member.

With this, the second component is arranged across the first component. Thus, when the first component is displaced downward due to distortion of the first side plate, twist of the recording unit can be suppressed.

Further, the first component and the second component are arranged at positions close to the supporting member. Thus, position deviation of the supporting member from the pair of side plates or posture fluctuation at the time of occurrence of distortion in the recording unit can be suppressed.

With this, even when the first side plate is distorted, the medium can be transported as appropriate.

In addition, the recorder is positioned at a position facing the supporting member. Thus, position deviation of the recorder from the pair of side plates or posture fluctuation can also be suppressed.

According to the first aspect or the second aspect, in a third aspect, the recording unit is supported at one position being a first supported portion at the first side plate, and is supported at two positions being a second supported portion and a third supported portion at the second side plate. When the transport path of the medium is viewed from a side, the second supported portion is positioned the inner side of the upstream extension region, and the third supported portion is positioned on the inner side of the downstream extension region.

According to this aspect, the recording unit is supported at one position being the first supported portion at the first side plate, and is supported at two positions being the second supported portion and the third supported portion at the second side plate. Thus, while the second side plate securely supports the recording unit, the distortion of first side plate can be prevented from affecting the recording unit more securely.

According to the first aspect, in a fourth aspect, when the transport path of the medium is viewed from a side, the second supported portion is positioned the inner side of the upstream extension region, and the third supported portion is positioned on the inner side of the downstream extension region. When the transport path of the medium is viewed from a side, the first supported portion is positioned on a linear line coupling a rotation center of the first pulley and a rotation center of the second pulley to each other. When the transport path of the medium is viewed from a side, the second supported portion is positioned on a linear line obtained by extending, toward upstream of the transport path, the linear line coupling the rotation center of the first pulley and the rotation center of the second pulley to each other. When the transport path of the medium is viewed from a side, the third supported portion is positioned on a linear line obtained by extending, toward downstream of the transport path, the linear line coupling the rotation center of the first pulley and the rotation center of the second pulley to each other.

According to this aspect, each of the first supported portion, the second supported portion, and the third supported portion is on the linear line coupling the rotation center of the first pulley and the rotation center of the second pulley to each other or on the extension line of the linear line, when the transport path of the medium is viewed from a side. In this configuration, the actions and effects of the above-mentioned first aspect can be obtained.

According to the third aspect or the fourth aspect, in a fifth aspect, the first supported portion is within a region of the recorder in the transport direction of the medium.

According to this aspect, the first supported portion is within the region of the recorder in the transport direction of the medium. Thus, posture fluctuation of the recorder with respect to the pair of side plates at the time of distortion of the first side plate can be suppressed.

According to any one of the third aspect to the fifth aspect, in a sixth aspect, the recording unit includes a first sub frame being a frame facing the first side plate and including the first supported portion, and a second sub frame being a frame facing the second side plate and including the second supported portion and the third supported portion.

According to this aspect, the recording unit includes the first sub frame being a frame facing the first side plate and including the first supported portion, and the second sub frame being a frame facing the second side plate and including the second supported portion and the third supported portion. In this configuration, the actions and effects of any one of the second aspect to the fourth aspects described above can be obtained.

According to the sixth aspect, in a seventh aspect, the first supported portion is formed as a first supported protrusion that is fitted in a first supporting hole formed in the first side plate, the second supported portion is formed as a second supported protrusion that is fitted in a second supporting hole formed in the second side plate, the third supported portion is formed as a third supported protrusion that is fitted in a third supporting hole formed in the second side plate, and a larger gap is secured for fitting between the third supported protrusion and the third supporting hole, as compared to fitting between the second supported protrusion and the second supporting hole.

According to this aspect, a larger gap is secured for fitting between the third supported protrusion and the third supporting hole, as compared to fitting between the second supported protrusion and the second supporting hole. Thus, variation of the distance between the second supported protrusion and the third supported protrusion can be canceled by the gap. With this, the recording unit can be mounted to the pair of side plates as appropriate.

According to the seventh aspect, in an eighth aspect, the second side plate has a through hole through which the recording unit passes, and when the recording unit moves toward the first side plate through the through hole, the first supported protrusion enters the first supporting hole, the second supported protrusion enters the second supporting hole, and the third supported protrusion enters the third supporting hole.

According to this aspect, workability for mounting the recording unit to the pair of side plates is facilitated.

According to the eighth aspect, in a ninth aspect, the first side plate and the second side plate are coupled to each other via a coupling member, and when the recording unit moves toward the first side plate through the through hole, the coupling member supports the recording unit and guides the recording unit toward the first side plate.

According to this aspect, when the recording unit moves toward the first side plate through the through hole, the coupling member supports the recording unit, and guides the recording unit toward the first side plate. Thus, workability for mounting the recording unit to the pair of side plates is more facilitated.

According to the ninth aspect, in a tenth aspect, the recorder includes a liquid ejection head configured to eject a liquid onto the medium, and a liquid storage between the first side plate and the second side plate, the liquid storage being configured to accommodate the liquid ejected from the liquid ejection head. The coupling member separates an arrangement region the liquid storage and an arrangement region of the recorder from each other between the first side plate and the second side plate.

According to this aspect, in addition to a function of coupling the first side plate and the second side plate to each other and a function of supporting the recording unit and guiding the recording unit toward the first side plate, the coupling member also has a function of separating the arrangement region of the liquid storage and the arrangement region of the recorder from each other between the first side plate and the second side plate. Thus, the number of components can be reduced, and hence increase in size and cost of the apparatus can be suppressed.

According to any one of the first aspect to the tenth aspect, in an eleventh aspect, the recording unit is coupled to the first side plate with play, the play is play in a direction in which the first side plate is at least away from the second side plate, the recording unit is coupled to the first side plate by a stepped screw, the stepped screw has a head portion, a screw portion that is fitted in a screw hole in the recording unit, and a cylinder portion having a diameter larger than the screw portion and being provided between the head portion and the screw portion, and the cylinder portion is inserted into a through hole formed in the first side plate.

According to this aspect, the recording unit is coupled to the first side plate with play. Thus, while defining the position of the recording unit with respect to the pair of side plates, distortion of the first side plate can be prevented from affecting the recording unit.

Further, the play is play in the direction in which the first side plate is at least away from the second side plate. Thus, distortion of the first side plate in the direction in which the first side plate is away from the second side plate is less likely to affect the recording unit.

Further, the stepped screw is used. With this, the play can be secured, and the first side plate and the recording unit can easily be coupled to each other.

According to any one of the first aspect to the eleventh aspect, in a twelfth aspect, a leg portion is provided at each of four corners of a bottom portion of an apparatus main body.

According to this aspect, in the configuration in which the leg portion is provided at each of the four corners of the bottom portion of the apparatus body, the actions and effects in any one of the first aspect to the twelfth aspect can be obtained.

The present disclosure is described below in detail.

An ink-jet printer 1 performs recording by ejecting a liquid, which is representatively exemplified by ink, onto a medium, which is representatively exemplified by recording paper. Such a printer is described below as an example of a recording apparatus. In the following description, the ink-jet printer 1 is referred to as a printer 1 in an abbreviated manner. The printer 1 corresponds to a recording apparatus according to a first exemplary embodiment.

An X-Y-Z coordinate system illustrated in each of the drawings is an orthogonal coordinate system. A Y-axis direction corresponds to a width direction intersecting the transport direction of the medium, and also corresponds to the apparatus depth direction. A +Y direction being a direction in which the arrow is oriented in the Y-axis direction corresponds to a direction from an apparatus front surface to an apparatus back surface, and a −Y direction opposite to the +Y direction corresponds to a direction from the apparatus back surface to the apparatus front surface.

Further, an X-axis direction corresponds to the width direction of the apparatus. A +X direction being a direction in which the arrow is oriented as viewed from an operator of the printer 1 corresponds to a left side, and a −X direction opposite thereto corresponds to a right side. The Z-axis direction corresponds to a vertical direction, that is, the height direction of the apparatus. A +Z direction being a direction in which the arrow is oriented corresponds to an upper direction, and a −Z direction opposite thereto corresponds to a lower direction. In the following description, the term “up” in indicates the +Z direction, and the term “down” indicates the −Z direction.

Further, a G-axis direction corresponds to a normal line direction of a line head 34, which is described later, with respect to an ink ejection surface 35. A +G direction being a direction in which the arrow is oriented corresponds to a direction in which a head unit 33 is away from a transport belt 7, and a −G direction opposite thereto is a direction in which the head unit 33 approaches the transport belt 7.

Further, an F-axis direction corresponds to a direction parallel to the ink ejection surface 35. A +F direction being the medium transport direction at a position facing the ink ejection surface 35 and a direction in which the arrow is oriented corresponds to downstream in the transport direction, and a −F direction opposite thereto corresponds to upstream in the transport direction. Note that, in the following description, a side to which the medium is fed is referred to as “downstream”, and a side opposite thereto is referred to as “upstream” in some cases. Further, the F-axis direction is a moving direction of a cap carriage 31 described later.

Further, in some of the drawings, an F-G-Y coordinate system is used in place of the X-Y-Z coordinate system.

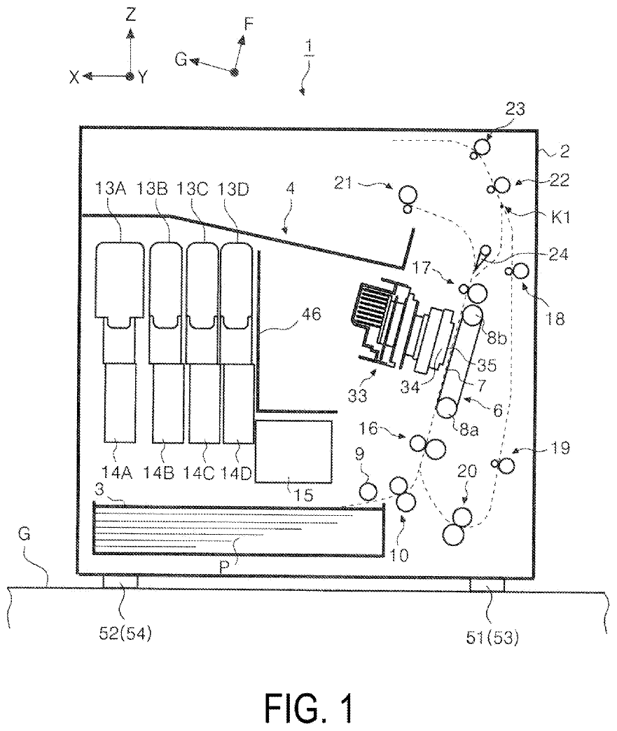

In FIG. 1, a medium transport path is indicated with the broken line. In the printer 1, the medium is transported in the medium transport path indicated with the broken line.

An apparatus main body 2 of the printer 1 includes a medium cassette 3 that accommodates the medium before feeding. The reference symbol P indicates the medium accommodated in each medium cassette. The medium cassette 3 is provided to the apparatus main body 2 so as to be removed from the apparatus front side.

The medium cassette 3 is provided with a pick roller 9 that feeds out the accommodated medium. The medium fed out by the pick roller 9 is fed obliquely upward by a feeding roller pair 10.

Note that, in the following description, the term “roller pair” includes a driving roller driven by a motor, which is not illustrated, and a driven roller to rotate in contact with the driving roller, unless otherwise noted.

The medium is fed from the feeding roller pair 10 to a transport roller pair 16. The medium that receives a feeding force from the transport roller pair 16 is fed to a position between the line head 34 and the transport belt 7, that is, a position facing the line head 34.

The line head 34 performs recording by ejecting an ink onto a surface of the medium. The line head 34 is an ink ejection head configured so that nozzles (not illustrated) for ejecting an ink cover the entire medium in the width direction, and is configured as an ink ejection head capable of performing recording on the entire medium in the width direction without moving in the medium width direction. The line head 34 is an example of a liquid ejection head that ejects a liquid.

The reference symbols 13A, 13B, 13C, and 13D indicate ink storages as liquid storages. The ink ejected from the line head 34 is supplied from each of the ink storages to the line head 34 via tube omitted in illustration. The ink storages 13A, 13B, 13C, and 13D are provided to mounters 14A, 14B, 14C, and 14D, respectively, so as to be removed from the apparatus front surface side.

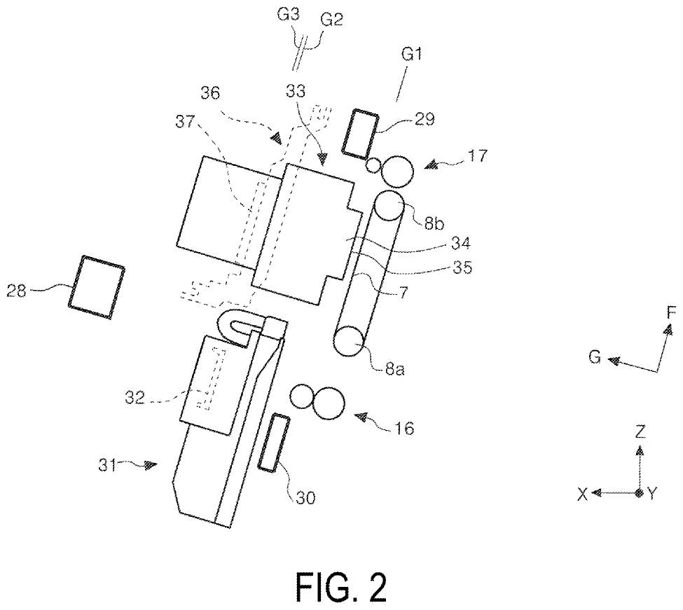

Further, the reference symbol 15 indicates a waste liquid storage that stores the ink as a waste liquid. The waste liquid is ejected from the line head 34 to a cap 32 (see FIG. 2), which is described later, for the purpose of maintenance work.

Note that the reference symbol 46 indicates a second partition frame that separates the arrangement region of the head unit 33 and the arrangement region of the ink storages 13A, 13B, 13C, and 13D from each other. The second partition frame is described later.

The transport belt 7, a first pulley 8a, and a second pulley 8b constitute a transport unit 6. The transport belt 7 is an endless belt that is stretched around the first pulley 8a and the second pulley 8b that are arranged along the medium transport direction. The transport belt 7 rotates when at least one of the first pulley 8a and the second pulley 8b is driven by a motor, which is not illustrated.

The medium is transported is sucked on a belt surface of the transport belt 7, and is transported along the position facing the line head 34. For suction of the medium on the transport belt 7, a publicly-known suction method such as an air suction method and an electrostatic suction method may be adopted.

Here, the medium transport path passing through the position facing the line head 34 intersects both the horizontal direction and the vertical direction, and has a configuration in which the medium is transported obliquely upward. The obliquely upward transport direction is a direction including a −X direction component and a +Z direction component in FIG. 1. With this configuration, the dimension of the printer 1 in the horizontal direction can be suppressed.

Note that, in the present exemplary embodiment, the medium transport path passing through the position facing the line head 34 is set to have an inclination angle falling within the range from 70 degrees to 80 degrees with respect to the horizontal direction, and is set to have an inclination angle of 75 degrees, as an example.

The medium having a first surface subjected to recording by the line head 34 is further fed obliquely upward by a transport roller pair 17 positioned downstream of the transport belt 7.

A flap 24 is provided downstream of the transport roller pair 17, and the flap 24 switches the transport direction of the medium. When the medium is directly discharged, the flap 24 switches the transport path of the medium toward a transport roller pair 21 provided above. When the medium is fed toward the transport roller pair 21, the medium is discharged onto a discharge tray 4. The discharge tray 4 is a tray that is inclined obliquely upward in a direction including a +X direction component and a +Z direction component.

When recording is further performed on a second surface in addition to the first surface of the medium, the medium is fed by the flap 24 obliquely upward in a direction including a −X direction component and a +Z direction component, passes through a branching position K1, and is fed from the branching position K1 to a switch-back path above. The switch-back path is provided with transport roller pairs 22 and 23. The medium that reaches the switch-back path is transported upward by the transport roller pairs 22 and 23. Further, when the trailing edge of the medium passes through the branching position K1, rotation of the transport roller pairs 22 and 23 is switched. With this, the medium is transported downward.

The medium that is transported downward by the transport roller pairs 22 and 23 receives a feeding force from a transport roller pair 18, a transport roller pair 19, and a transport roller pair 20, arrives at the transport roller pair 16, and then is fed again to the position facing the line head 34 by the transport roller pair 16. When the medium that is fed again to the position facing the line head 34, the second surface opposite to the first surface on which recording is already performed faces the line head 34. With this, the line head 34 is capable of performing recording on the second surface of the medium. The medium having the second surface on which recording is performed is discharged by the transport roller pair 21.

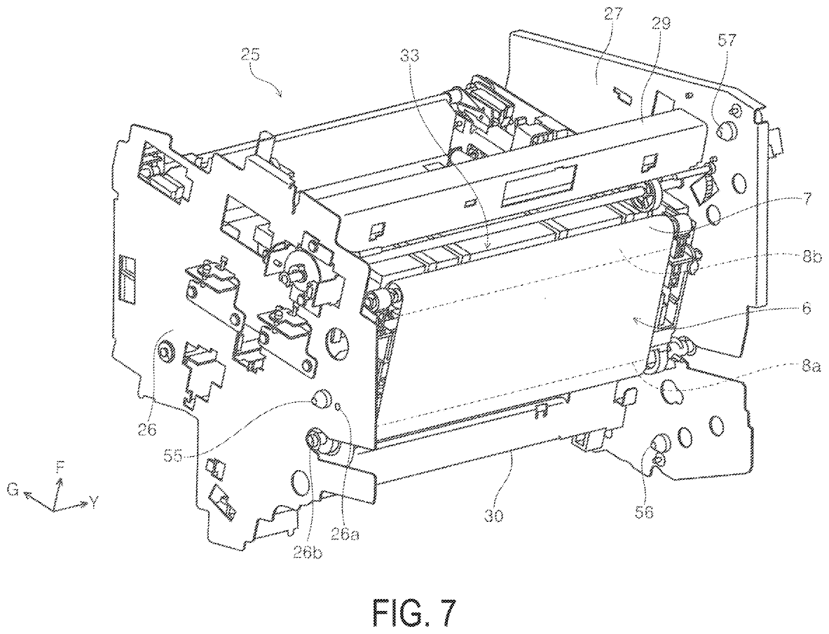

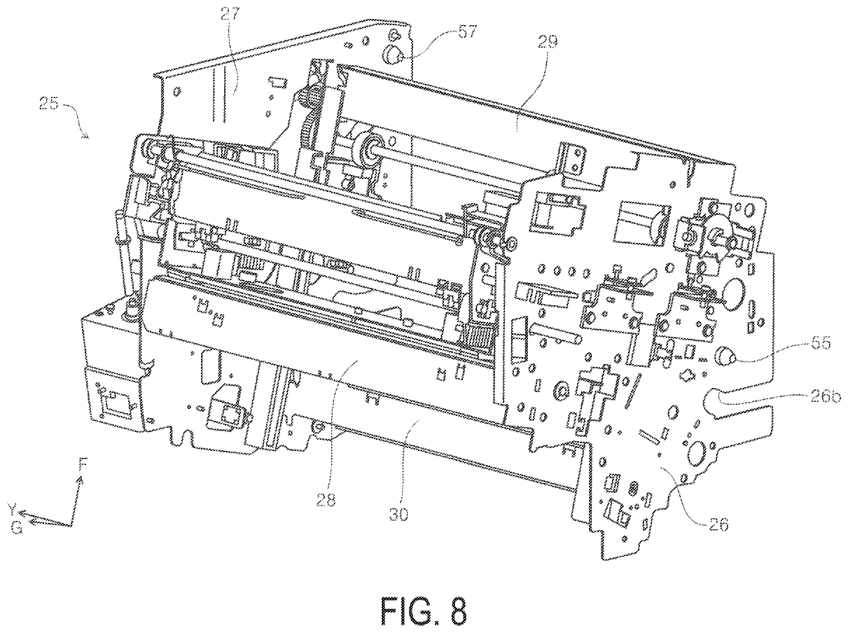

Next, a motion unit 25 is described. The motion unit 25 (see FIG. 7) is an example of the recording unit. The motion unit 25 includes the head unit 33, the cap carriage 31, and a wiper carriage 36 that are illustrated in FIG. 2. Note that, in FIG. 7, the cap carriage 31 and the wiper carriage 36 are omitted in illustration. Further, in FIG. 8, the head unit 33, the cap carriage 31, and the wiper carriage 36 are omitted in illustration.

In FIG. 2, the head unit 33 is a unit including the line head 34, and is provided so as to be driven by a motor, which is not illustrated, along the G-axis direction. The head unit 33 is an example of a recorder.

In FIG. 2, the cap carriage 31 is an example of a cap unit including the cap 32 for covering the line head 34, and is provided so as to be driven by a motor, which is not illustrated, along the F-axis direction.

The wiper carriage 36 is a unit provided with a wiper 37 for performing wiping on the ink ejection surface 35 of the line head 34, and is provided so as to be driven by a motor, which is not illustrated, along the Y-axis direction.

In this manner, the head unit 33, the cap carriage 31, and the wiper carriage 36 are provided in the motion unit 25 in directions orthogonal to one another so as to be driven.

FIG. 2 illustrates positions of the respective units when the line head 34 performs recording on the medium. A position G1 is a position of the ink ejection surface 35 in the G-axis direction in this state. In this state, the cap carriage 31 is at a retracting position in the −F direction with respect to the head unit 33, and the wiper carriage 36 is at a home position set in the +Y direction.

When the ink ejection surface 35 is capped with the cap 32 included in the cap carriage 31 from this state, the head unit 33 retracts in the +G direction from the position in FIG. 2, and the cap carriage 31 moves in the +F direction. With this, the ink ejection surface 35 and the cap 32 face each other. When the ink ejection surface 35 and the cap 32 face each other, the head unit 33 moves in the −G direction. With this, the ink ejection surface 35 is capped with the cap 32. A position G2 is a position of the ink ejection surface 35 in the G-axis direction when the ink ejection surface 35 is capped with the cap 32.

When the wiper 37 included in the wiper carriage 36 performs wiping on the ink ejection surface 35, the head unit 33 retracts in the +G direction from the state in FIG. 2. Further, the wiper carriage 36 moves from the home position in the +Y direction to an end position in the −Y direction. After that, the head unit 33 slightly moves in the −G direction, and the wiper carriage 36 moves in the +Y direction while the ink ejection surface 35 is at a position G3. With this, the wiper 37 performs wiping on the ink ejection surface 35.

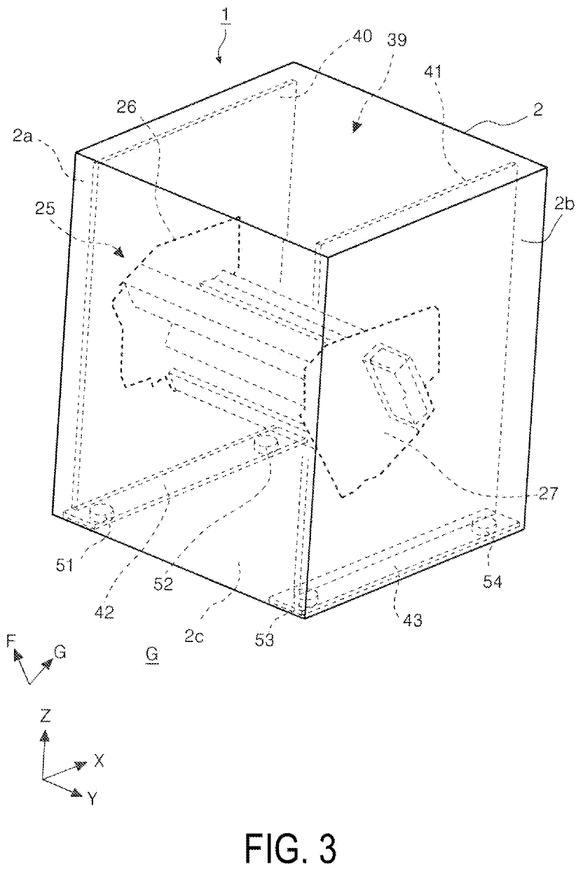

Subsequently, as illustrated in FIG. 3, FIG. 7, and FIG. 8, the motion unit 25 includes a first sub frame 26 and a second sub frame 27 that is positioned in the +Y direction with respect to the first sub frame 26. Each of the first sub frame 26 and the second sub frame 27 is formed of a metal plate material, and forms a frame surface along an F-G plane.

As illustrated in FIG. 7 and FIG. 8, the first sub frame 26 and the second sub frame 27 are coupled to each other with a first coupling frame 28, a second coupling frame 29, and a third coupling frame 30 that extend in the Y-axis direction. Each of the first coupling frame 28, the second coupling frame 29, and the third coupling frame 30 is formed by subjecting a metal plate material to bending processing.

In the present exemplary embodiment, the first coupling frame 28, the second coupling frame 29, and the third coupling frame 30 are joined to the first sub frame 26 and the second sub frame 27 by welding. With this, rigidity of the entire motion unit 25 is secured.

Each of the first coupling frame 28, the second coupling frame 29, and the third coupling frame 30 is obtained by bending processing so that a part or an entirety of a cross-section thereof, which is taken along the F-G plane, is square (see FIG. 2). With this, rigidity of the motion unit 25 is further improved.

As illustrated in FIG. 3, the apparatus main body 2 includes a front frame 40 at the end in the −Y direction, and includes a rear frame 41 at the end in the +Y direction. The front frame 40 and the rear frame 41 are collectively an example of a pair of side plates positioned across the motion unit 25. The front frame 40 is an example of the first side plate, and the rear frame 41 is an example of the second side plate.

The front frame 40 stands upright on a first bottom frame 42, and the rear frame 41 stands upright on a second bottom frame 43. Each of the front frame 40, the rear frame 41, the first bottom frame 42, and the second bottom frame 43 is formed of a metal material.

The motion unit 25 is supported by the front frame 40 and the rear frame 41. Further, the front frame 40, the rear frame 41, the first bottom frame 42, the second bottom frame 43, and the motion unit 25 constitute a frame structure body 39 being a base body of the apparatus main body 2.

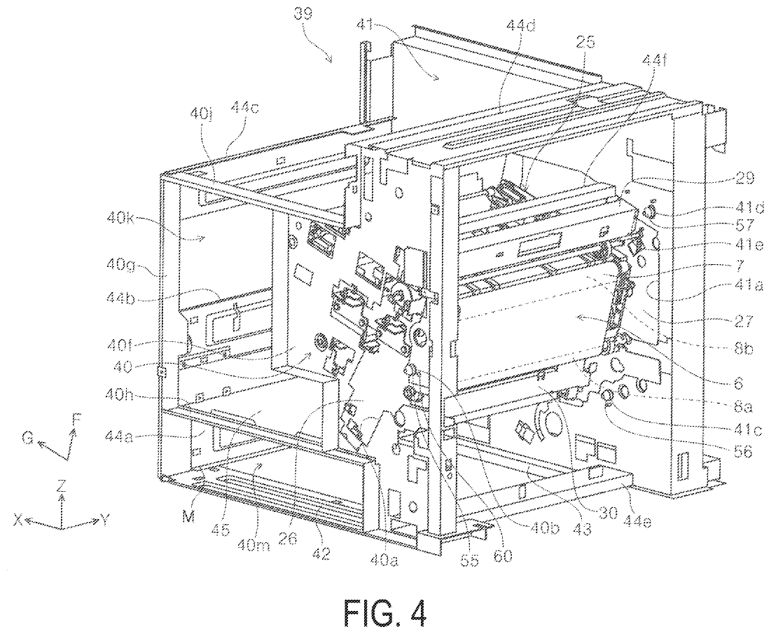

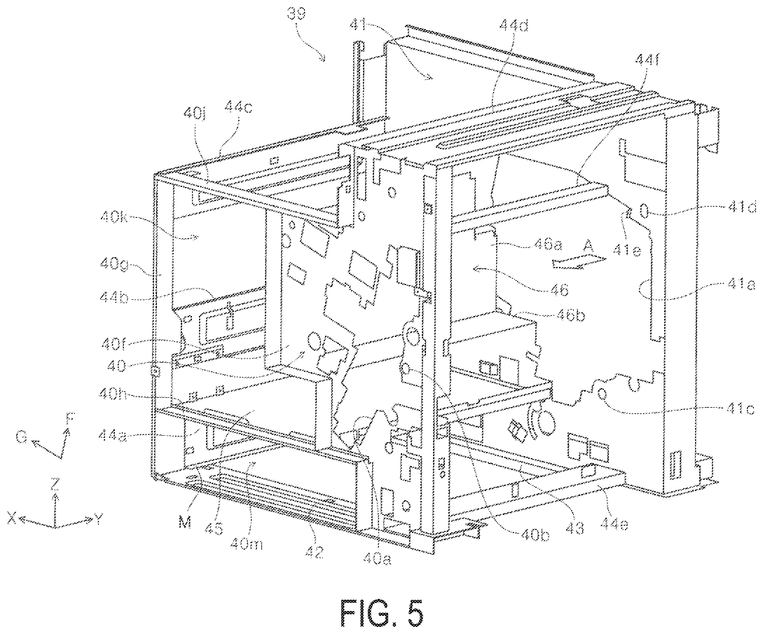

Note that FIG. 3 is a schematic view. In actuality, as illustrated in FIG. 4 and FIG. 5, the frame structure body 39 includes a plurality of stays and frames formed of metal materials in addition to the front frame 40, the rear frame 41, the first bottom frame 42, the second bottom frame 43, and the motion unit 25. This matter is described later.

Further, the exterior of the frame structure body 39 is a casing body formed of a resin material. However, description therefor is also omitted. The frame structure body 39 formed of a metal material and the casing body formed of a resin material constitute the apparatus main body 2.

As illustrated in FIG. 3, the front frame 40 forms a frame surface parallel to an X-Z plane so as to extend along a front surface 2a of the apparatus main body 2. Further, the rear frame 41 forms a frame surface parallel to the X-Z plane so as to extend along a back surface 2b of the apparatus main body 2. The first bottom frame 42 and the second bottom frame 43 form a frame surface parallel to an X-Y plane so as to extend along a bottom surface 2c of the apparatus main body 2.

The first bottom frame 42 is provided with a front right leg portion 51 and a front left leg portion 52, and the second bottom frame 43 is provided with a rear right leg portion 53 and a rear left leg portion 54. In other words, the leg portions are provided at the four corners of the apparatus main body 2, respectively. The apparatus main body 2 is placed on a placement surface G via the four leg portions including the front right leg portion 51, the front left leg portion 52, the rear right leg portion 53, and the rear left leg portion 54. Note that, in the following description, when there is no particular need to distinguish the front right leg portion 51, the front left leg portion 52, the rear right leg portion 53, and the rear left leg portion 54 from one another, those portions are simply referred to as a “leg portion” in some cases.

Subsequently, the configuration of the frame structure body 39 is further described in detail.

As illustrated in FIG. 4 and FIG. 5, the front frame 40 has a first opening portion 40a for exposing the first sub frame 26 of the motion unit 25. A second opening portion 40k is formed in the first opening portion 40a in the +X direction. Further, a third opening portion 40m is formed below the second opening portion 40k.

The second opening portion 40k is an opening portion for accessing the ink storages 13A, 13B, 13C, and 13D, the mounters 14A, 14B, 14C, and 14D, and the waste liquid storage 15, which are described with reference to FIG. 1, from the apparatus front side.

Further, the third opening portion 40m is an opening portion for mounting and removing the medium cassette 3, which is described with reference to FIG. 1, from the apparatus front side.

The front frame 40 is obtained by welding a plurality of members. Specifically, the front frame 40 is obtained by including the first frame portion 40f having the first opening portion 40a formed therein, as a base, and welding a second frame portion 40g, a third frame portion 40h, a fourth frame portion 40j, and the first bottom frame 42 to one another.

The second frame portion 40g extends along the Z-axis direction, and forms a left edge of the second opening portion 40k. The third frame portion 40h extends along the X-axis direction, and forms a lower edge of the second opening portion 40k and forms an upper edge of the third opening portion 40m. The first bottom frame 42 extends along the X-axis direction, and forms a lower edge of the third opening portion 40m.

In this manner, the front frame 40 is obtained by coupling the plurality of frames to one another. With this, while the second opening portion 40k and the third opening portion 40m are formed, the front frame 40 with secured rigidity can be obtained at low cost.

In FIG. 4 and FIG. 5, an opening portion 41a being a through hole through which the motion unit 25 passes is formed in the rear frame 41. When the motion unit 25 is arranged between the front frame 40 and the rear frame 41, the motion unit 25 moves from the +Y direction to the −Y direction with respect to the rear frame 41, as indicated with the arrow A in FIG. 5. With this, a first supported protrusion 55 provided to the motion unit 25 enters a first supporting hole 40b provided in the front frame 40, a second supported protrusion 56 provided to the motion unit 25 enters a second supporting hole 41c provided in the rear frame 41, and a third supported protrusion 57 provided to the motion unit 25 enters a third supporting hole 41d provided in the rear frame 41. Specifically, the motion unit 25 is supported by the front frame 40 and the rear frame 41.

Note that, in the following description, when there is no particular need to distinguish the first supported protrusion 55, the second supported protrusion 56, and the third supported protrusion 57 from one another, those protrusions are simply referred to as a supported protrusion in some cases. Similarly, in the following description, when there is no particular need to distinguish the first supporting hole 40b, the second supporting hole 41c, and the third supporting hole 41d from one another, those supporting holes are simply referred to as a supporting hole in some cases.

In this manner, the motion unit 25 moves toward the front frame 40 through the opening portion 41a. With this, the respective supported protrusions enter the respective supporting holes, and the motion unit 25 is supported by the front frame 40 and the rear frame 41. Thus, workability for mounting the motion unit 25 to the front frame 40 and the rear frame 41 is facilitated.

Note that the respective supported protrusions and the respective supporting holes are described later again in detail.

The front frame 40 and the rear frame 41 are coupled to each other with a plurality of stays. Specifically, the front frame 40 and the rear frame 41 are coupled to each other with the first stay 44a, a second stay 44b, a third stay 44c, a fourth stay 44d, a fifth stay 44e, and a sixth stay 44f. Each of the stays is a stay extending along the Y-axis direction, is formed of a metal material, and is fixed to the front frame 40 and the rear frame 41 by welding or screwing.

Note that the first stay 44a has a bent portion M obtained by bending a side, which is close to the bottom surface 2c of the apparatus main body 2, to the inner side of the apparatus main body 2 so as to have an L-like shape. Rollers (not illustrated) of the medium cassette 3 are placed on the bend portion M, thereby exerting a function as a cassette rail. With this structure, there is no need to prepare additional cassette rail components. Thus, the number of components can be reduced, and hence increase in size and cost of the apparatus can be suppressed.

Further, a first partition frame 45 and the second partition frame 46 are provided between the front frame 40 and the rear frame 41. In other words, the front frame 40 and the rear frame 41 are coupled to each other by the first partition frame 45 and the second partition frame 46 in addition to the respective stays described above.

The first partition frame 45 forms a surface parallel to the X-Y plane, and forms an accommodation space for accommodating the medium cassette 3 (see FIG. 1).

The second partition frame 46 has an L-like shape as viewed in the +Y direction so as to have a first part 46a forming a surface parallel to a Y-Z plane and a second part 46b forming a surface parallel to the X-Y plane. The second partition frame 46 has a function of separating the arrangement region of the head unit 33 and the arrangement region of the ink storages 13A, 13B, 13C, and 13D from each other between the front frame 40 and the rear frame 41.

Here, when the motion unit 25 moves toward the front frame 40 through the opening portion 41a, the second partition frame 46 supports the motion unit 25 with the second part 46b, and guides the motion unit 25 toward the front frame 40. Note that the component of the motion unit 25 that is supported by the second partition frame 46 is the first coupling frame 28 (see FIG. 8).

With this, workability for mounting the motion unit 25 to the front frame 40 and the rear frame 41 is further facilitated.

Further, the second partition frame 46 also has a function of separating the arrangement region of the head unit 33 and the arrangement region of the ink storages 13A, 13B, 13C, and 13D from each other, in addition to a function of supporting and guiding the motion unit 25 toward the front frame 40. Thus, the number of components can be reduced, and hence increase in size and cost of the apparatus can be suppressed.

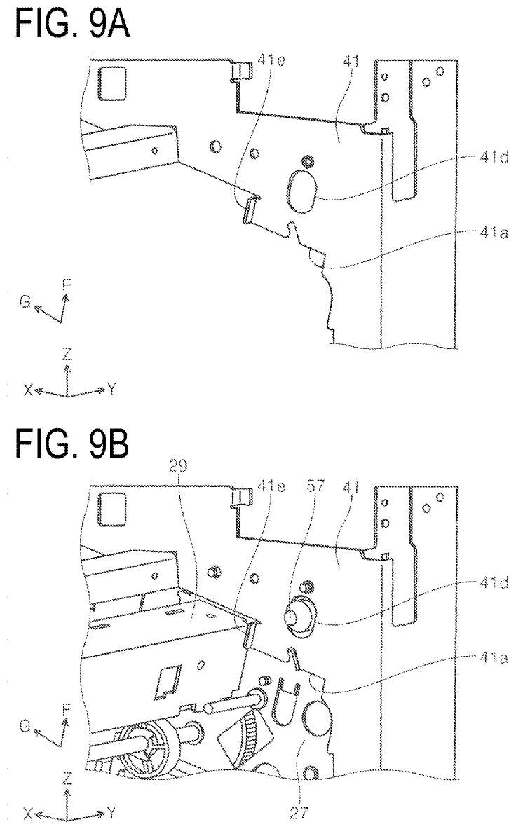

Note that, as illustrated in FIG. 9A and FIG. 9B, a bent upright portion 41e is formed at the opening portion 41a of the rear frame 41. The bent upright portion 41e is formed in the vicinity of the third supporting hole 41d, and is formed so as to be bent in the −Y direction. When the motion unit 25 moves toward the front frame 40 through the opening portion 41a, the bent upright portion 41e supports the motion unit 25 together with the second partition frame 46 described above. Note that, as illustrated in FIG. 9B, the component of the motion unit 25 that is supported by the bent upright portion 41e is the second coupling frame 29.

Note that the distance between the third supporting hole 41d and the bent upright portion 41e is set so that the second coupling frame 29 is away from the bent upright portion 41e when the respective supported protrusions are supported by the respective supporting holes. Similarly, the position of the second part 46b is set so that the first coupling frame 28 is away from the second part 46b of the second partition frame 46 when the respective supported protrusions are supported by the respective supporting holes. With this, under a state in which the respective supported protrusions are supported by the respective supporting holes, the bent upright portion 41e and the second partition frame 46 can be prevented from disadvantageously affecting positioning accuracy of the respective supported protrusions by the respective supporting holes.

Next, a gravity center position of the apparatus main body 2 is described. Further, along with this, description is made on distortion of the frame when any one of the four leg portions stands on a protruding portion (not illustrated) on the placement surface G.

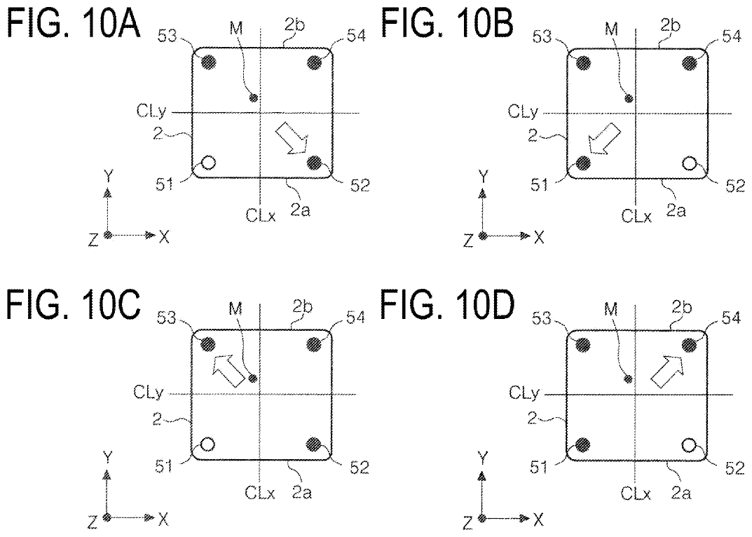

FIG. 10 is a plan view of the bottom surface 2c as the apparatus main body 2 is viewed from below. In FIG. 10, a linear line CLx is a linear line parallel to the Y axis, and is a linear line passing through the center position of the apparatus main body 2 in the X-axis direction. Further, a linear line CLy is a linear line parallel to the X axis, and is a linear line passing through the center position of the apparatus main body 2 in the Y-axis direction. Note that the center position of the apparatus main body 2 in the Y-axis direction is also an intermediate position of the front frame 40 and the rear frame 41 in the Y-axis direction.

The reference symbol M indicates a gravity center position of the apparatus main body 2. As illustrated, the gravity center position M of the apparatus main body 2 is on the rear side (in the +Y direction with respect to the linear line CLy) in the apparatus front-rear direction (in the Y-axis direction), in other words, on a side close to the rear frame 41. Further, the gravity center position M is on the right side (in the −X direction with respect to the linear line CLx) in the apparatus right-left direction (in the X-axis direction).

With this configuration as described above, in a case in which the protruding portion caused by a bump, a foreign matter, or the like is on the placement surface G (see FIG. 1 and FIG. 3), when any one of the four leg portions stands on the protruding portion, the frame structure body 39 is distorted.

Details are further described below. The leg portion indicated with the outlined arrow in FIG. 10 is a leg portion that stands on the protruding portion of the placement surface G. The painted leg portion is a leg portion in contact with the placement surface G. The outlined leg portion is a leg portion that floats from the placement surface G.

For example, FIG. 10A illustrates a case in which the front left leg portion 52 stands of the protruding portion of the placement surface G. In this case, the gravity center of the apparatus main body 2 is on the rear side, and hence the apparatus main body 2 in inclined to the rear side (in the +Y direction). As a result, the front left leg portion 52, the rear right leg portion 53, and the rear left leg portion 54 are held in contact with the placement surface G, and the front right leg portion 51 floats from the placement surface G.

Further, FIG. 10B illustrates a case in which the front right leg portion 51 stands of the protruding portion of the placement surface G. In this case, the gravity center of the apparatus main body 2 is on the rear side, and hence the apparatus main body 2 in inclined to the rear side (in the +Y direction). As a result, the front right leg portion 51, the rear right leg portion 53, and the rear left leg portion 54 are held in contact with the placement surface G, and the front left leg portion 52 floats from the placement surface G.

Further, FIG. 10C illustrates a case in which the rear right leg portion 53 stands on the protruding portion of the placement surface G. In this case, the apparatus main body 2 is inclined to the left side (in the +X direction). As a result, the front left leg portion 52, the rear right leg portion 53, and the rear left leg portion 54 are held in contact with the placement surface G, and the front right leg portion 51 floats from the placement surface G.

Further, FIG. 10D illustrates a case in which the rear left leg portion 54 stands on the protruding portion of the placement surface G. In this case, the apparatus main body 2 is inclined to the right side (in the −X direction). As a result, the front right leg portion 51, the rear right leg portion 53, and the rear left leg portion 54 are held in contact with the placement surface G, and the front left leg portion 52 floats from the placement surface G.

Specifically, even when any one of the four leg portions stands on the protruding portion of the placement surface G, the apparatus front side floats. Thus, any one of the front right leg portion 51 and the front left leg portion 52 floats. The part floating from the placement surface G is not supported by the placement surface G, and hence the frame is distorted. Specifically, even when any one of the four leg portions stands on the protruding portion of the placement surface G, the front frame 40 is distorted.

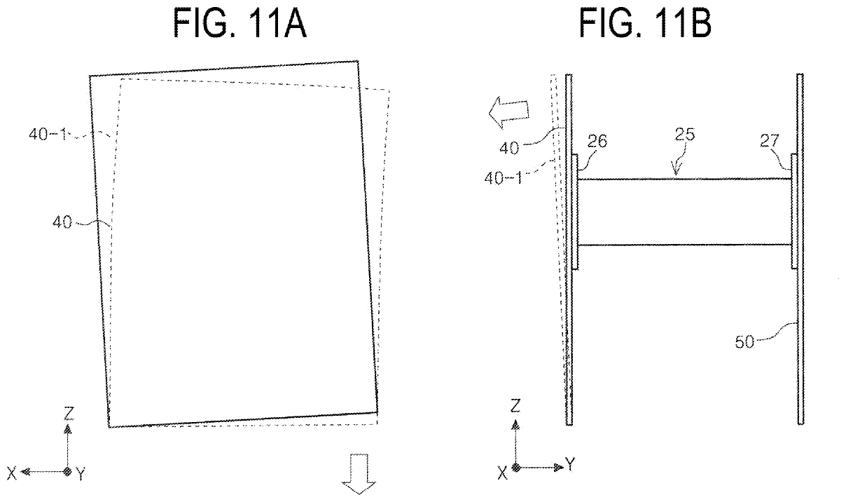

FIG. 11 schematically illustrates distortion occurring to the front frame 40 when the front right leg portion 51 floats, and the broken line and the reference symbol 40-1 indicate the front frame 40 that is distorted. When the front right leg portion 51 floats, the front frame 40 is deformed downward as indicated with the arrow in the apparatus front view, as illustrated in FIG. 11A. Further, as illustrated in FIG. 11B, there may be a case in which the front frame 40 is deformed so as to fall frontward as indicated with the arrow in the apparatus side view.

Note that the present exemplary embodiment includes the four leg portions, but is not limited thereto. Five or more leg portions may be provided. Further, in a case in which the apparatus bottom surface is not provided with the leg portion, when the gravity center of the apparatus main body 2 is on the rear side, the apparatus front side floats similarly to the above-mentioned case. Thus, the front frame 40 is distorted.

In view of the above-mentioned problem, in the printer 1, first, the number of components of the motion unit 25 that are supported by the front frame 40 is smaller than the number of components thereof that are supported by the rear frame 41.

Specifically, as illustrated in FIG. 4, the motion unit 25 includes the three supported protrusions including the first supported protrusion 55, the second supported protrusion 56, and the third supported protrusion 57. Those supported protrusions are supported by the front frame 40 and the rear frame 41.

Among those three supported protrusions, the first supported protrusion 55 is provided to the first sub frame 26 that faces the front frame 40, and the second supported protrusion 56 and the third supported protrusion 57 are provided to the second sub frame 27 that faces the rear frame 41. Each of the protrusions has a perfect circle shape as viewed in the Y-axis direction. Further, each of the protrusions protrudes from the surface of each of the frames from the −Y direction to the −Y direction, and has such a shape that partially maintains a constant outer diameter and is tapered as approaching the −Y direction. Each of the protrusions is formed of a metal material in the present exemplary embodiment.

Further, in the first sub frame 26, the first supported protrusion 55 is provided in the vicinity of a bearing portion 26b (see FIG. 7) that supports the first pulley 8a.

The first supporting hole 40b that the first supported protrusion 55 enters is formed in the front frame 40. The second supporting hole 41c that the second supported protrusion 56 enters and the third supporting hole 41d that enters the third supported protrusion 57 are formed in the rear frame 41.

The first supporting hole 40b is formed in the vicinity of the first opening portion 40a. Further, the second supporting hole 41c and the third supporting hole 41d are formed in the vicinity of the edge of the opening portion 41a.

Further, when the first supported protrusion 55 enters the first supporting hole 40b, the motion unit 25 is supported on the side close to the front frame 40. Further, when the second supported protrusion 56 enters the second supporting hole 41c, and the third supported protrusion 57 enters the third supporting hole 41d, the motion unit 25 is supported on the side close to the rear frame 41.

Note that, in the present exemplary embodiment, the third supporting hole 41d is formed so as to be an elongated hole in the F-axis direction, and is configured to cancel variation of the distance between the second supported protrusion 56 and the third supported protrusion 57 in the F-axis direction. With this, even when the distance between the second supported protrusion 56 and the third supported protrusion 57 in the F-axis direction varies, the motion unit 25 can be mounted to the rear frame 41 as appropriate.

Further, in the present exemplary embodiment, at least clearance fitting specified in JISB0405 or a gap larger than the clearance fitting is secured for fitting between the first supported protrusion 55 and the first supporting hole 40b and fitting between the second supported protrusion 56 and the second supporting hole 41c. With this, the respective supported protrusions are allowed to move at least within a predetermined range in the Y-axis direction with respect to the respective supporting holes.

Further, in the present exemplary embodiment, the motion unit 25 is supported with play in the Y-axis direction. Specifically, as illustrated in FIG. 4, the first sub frame 26 of the motion unit 25 is fixed to the front frame 40 in the vicinity of the first supporting hole 40b with a stepped screw 60. Note that, in the present exemplary embodiment, the second sub frame 27 of the motion unit 25 is not coupled to the rear frame 41.

However, the second sub frame 27 of the motion unit 25 may be coupled to the rear frame 41 with a screw or the like.

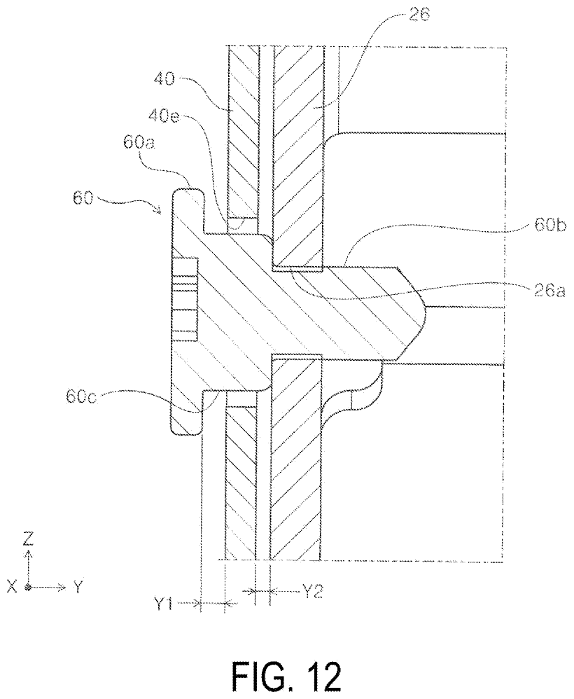

In FIG. 12, the stepped screw 60 has a head portion 60a, a screw portion 60b, and a cylinder portion 60c positioned between the head portion 60a and the screw portion 60b.

A screw hole 26a is formed in the first sub frame 26 of the motion unit 25, and the screw portion 60b of the stepped screw 60 is screw-fitted into the screw hole 26a of the first sub frame 26. A through hole 40e is formed in the front frame 40, and the cylinder portion 60c of the stepped screw 60 is inserted into the through hole 40e.

The inner diameter of the through hole 40e is sufficiently larger than the outer diameter of the cylinder portion 60c, and has such a size that does not hinder relative movement between the cylinder portion 60c and the front frame 40 in the Y-axis direction.

Further, the length of the cylinder portion 60c (the length in the Y-axis direction) is sufficiently larger than the thickness of the front frame 40 (the thickness in the Y-axis direction). In FIG. 12, the reference symbol Y1 indicates play for which the front frame 40 is allowed to move in the −Y direction with respect to the first sub frame 26, and the reference symbol Y2 indicates play for which the front frame 40 is allowed to move in the +Y direction with respect to the first sub frame 26. In the present exemplary embodiment, Y1+Y2 corresponds to secured play.

In this manner, the motion unit 25 is coupled to the front frame 40 with the play in the Y-axis direction.

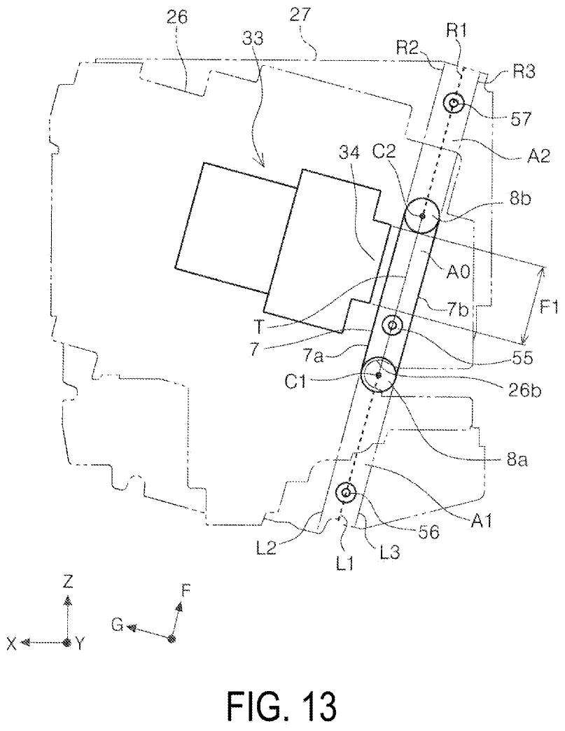

Next, with reference to FIG. 13, arrangement of the first supported protrusion 55, the second supported protrusion 56, and the third supported protrusion 57 is described in detail.

In FIG. 13, a line T is a liner line coupling a rotation center C1 of the first pulley 8a and a rotation center C2 of the second pulley 8b to each other, and is indicated with the solid line. Further, a line L1 is a linear line obtained by extending the line T toward upstream, and is indicated with the broken line. Further, a line R1 is a linear line obtained by extending the line T toward downstream, and is indicated with the broken line.

Further, the line L2 is a linear line obtained by extending a counter surface of the transport belt 7, which faces the line head 34, toward upstream, and is indicated with the one-dot chain line. Further, the line R2 is a linear line obtained by extending the counter surface of the transport belt 7, which faces the line head 34, toward downstream, and is indicated with the one-dot chain line.

Further, the line L3 is a linear line obtained by extending a surface of the transport belt 7, which does not face the line head 34, toward upstream, and is indicated with the one-dot chain line. Further, the line R3 is a linear line obtained by extending the surface of the transport belt 7, which does not face the line head 34, toward downstream, and is indicated with the one-dot chain line.

The reference symbol A0 indicates an inner region of the transport belt 7. Further, the reference symbol A1 indicates an upstream extension region obtained by extending the inner region A0 toward upstream. Further, the reference symbol A2 indicates a downstream extension region obtained by extending the inner region A0 toward downstream. The upstream extension region A1 is a region sandwiched between the line L2 and the line L3, and the downstream extension region A2 is a region sandwiched between the line R2 and the line R3. Note that the inner region A0 is a region in the first sub frame 26, and the upstream extension region A1 and the downstream extension region A2 are regions in the second sub frame 27.

As illustrated, the first supported protrusion 55 being a component of the motion unit 25 that is supported by the front frame 40 is positioned on the inner side of the inner region A0, which is the inner side of the transport belt 7, when the transport path of the medium is viewed from a side. The second supported protrusion 56 being a component of the motion unit 25 that is supported by the rear frame 41 is positioned on the inner side of the upstream extension region A1 when the transport path of the medium is viewed from a side. Further, the third supported protrusion 57 being a component of the motion unit 25 that is supported by the rear frame 41 is positioned on the inner side of the downstream extension region A2 when the transport path of the medium is viewed from a side.

With such a configuration, the following actions and effects can be obtained. Specifically, as described above, in the printer 1, the apparatus gravity center position M is on the side close to the rear frame 41 with respect to the intermediate position between the front frame 40 and the rear frame 41. With this, the protruding portion is present on the placement surface G of the apparatus, the front frame 40 is likely to be distorted.

Further, the number of components of the motion unit 25 that are supported by the front frame 40 is smaller than the number of components thereof that are supported by the rear frame 41, and hence distortion of the front frame 40 is less likely to affect the motion unit 25. With this, even when the front frame 40 is distorted, distortion of the motion unit 25 can be suppressed. Thus, position deviation of the transport belt 7 from the front frame 40 and the rear frame 41 and posture fluctuation can be suppressed, and the medium can be transported as appropriate.

Further, when the first supported protrusion 55 being the component of the motion unit 25 that is supported by the front frame 40 is displaced downward due to distortion of the front frame 40, the second supported protrusion 56 and the third supported protrusion 57 being the components of the motion unit 25 that are supported by the rear frame 41 are also displaced downward. In this case, when the first supported protrusion 55, and the second supported protrusion 56 and the third supported protrusion 57 are away from each other in the horizontal direction, the motion unit 25 is likely to be twisted and deformed. Thus, posture of the transport belt 7 with respect to the front frame 40 and the rear frame 41 is likely to change.

In addition, in the motion unit 25, when a location where distortion occurs in the motion unit 25 is farther away from the first supported protrusion 55, the second supported protrusion 56, and the third supported protrusion 57, there may be a risk that position deviation of the motion unit 25 from the front frame 40 and the rear frame 41 and posture fluctuation are more significant. Specifically, as the transport belt 7 is at a position farther away from the first supported protrusion 55, the second supported protrusion 56, and the third supported protrusion 57, position deviation of the transport belt 7 from the front frame 40 and the rear frame 41 and posture fluctuation are more significant.

Further, when position deviation of the transport belt 7 from the front frame 40 and the rear frame 41 and posture fluctuation are caused, relative position deviation between the transport belt 7 and the medium transport mechanisms (for example, the transport roller pairs 16 and 17) provided to the front frame 40 and the rear frame 41 and posture fluctuation are caused. Thus there may be a risk that appropriate transport cannot be performed.

However, as described above, when the transport path of the medium is viewed from a side, the first supported protrusion 55 is positioned on the inner side of the inner region A0, which is the inner side of the transport belt 7, the second supported protrusion 56 is positioned on the inner side of the upstream extension region A1, and the third supported protrusion 57 is positioned on the inner side of the downstream extension region A2.

With this, the second supported protrusion 56 and the third supported protrusion 57 are arranged so as to sandwich the first supported protrusion 55 therebetween. Thus, when the first supported protrusion 55 is displaced downward due to distortion of the front frame 40, twist of the motion unit 25 can be suppressed.

Further, the first supported protrusion 55, the second supported protrusion 56, and the third supported protrusion 57 are arranged at the positions close to the transport belt 7. Thus, when distortion occurs in the motion unit 25, position deviation of the transport belt 7 from the front frame 40 and the rear frame 41 and posture fluctuation can be suppressed.

With this, even when the front frame 40 is distorted, the medium can be transported as appropriate.

In addition, the line head 34 is at the position facing the transport belt 7, and hence position deviation of the line head 34 from the front frame 40 and the rear frame 41 and posture fluctuation can also be suppressed.

Further, the motion unit 25 is supported at one position being the first supported protrusion 55 on the front frame 40, and is supported at two positions being the second supported protrusion 56 and the third supported protrusion 57 on the rear frame 41. The second supported protrusion 56 is positioned on the inner side of the upstream extension region A1, and the third supported protrusion 57 is positioned on the inner side of the downstream extension region A2. With this, while the motion unit 25 is securely supported by the rear frame 41, distortion of the front frame 40 can securely be prevented from affecting the motion unit 25.

Further, the first supported protrusion 55 is positioned on the line T being a linear line coupling the rotation center C1 of the first pulley 8a and the rotation center C2 of the second pulley 8b to each other. The second supported protrusion 56 is positioned on the line L1 being a linear line obtained by extending the line T toward upstream, and the third supported protrusion is positioned on the line R1 obtained by extending the line T toward downstream.

Note that a range F1 in FIG. 13 is a region of the line head 34 in the transport direction of the medium. In the present exemplary embodiment, the first supported protrusion 55 is positioned on the outer side of the range F1, and may be positioned on the inner side of the range F1. With this, when the front frame 40 is distorted, posture fluctuation of the line head 34 with respect to the front frame 40 can be suppressed. Thus, appropriate recording quality can be achieved.

Note that, in the present exemplary embodiment, the interval between the first pulley 8a and the second supported protrusion 56 in the F-axis direction is equal to the interval between the second pulley 8b and the third supported protrusion 57.

Further, in the present exemplary embodiment, the first supported protrusion 55 is provided in the vicinity of the bearing portion 26b of the first sub frame 26 that supports the first pulley 8a.

Further, the first supported protrusion 55 is deviated from the intermediate position between the second supported protrusion 56 and the third supported protrusion 57 in the F-axis direction, and may be arranged at the intermediate position.

Further, in the present exemplary embodiment, the first supported protrusion 55 is positioned on the inner side of the inner region A0. However, a part of the first supported protrusion 55 may be positioned on the outer side of the inner region A0, or the entire first supported protrusion 55 may be positioned in the vicinity of the outer side of the inner region A0.

Further, in the present exemplary embodiment, the second supported protrusion 56 is positioned on the inner side of the upstream extension region A1. However, a part of the second supported protrusion 56 may be positioned on the outer side of the upstream extension region A1, or the entire second supported protrusion 56 may be positioned in the vicinity of the outer side of the upstream extension region A1.

Further, in the present exemplary embodiment, the third supported protrusion 57 is positioned on the inner side of the downstream extension region A2. However, a part of the third supported protrusion 57 may be positioned on the outer side of the downstream extension region A2, or the entire third supported protrusion 57 may be positioned in the vicinity of the outer side of the downstream extension region A2.

Further, in the present exemplary embodiment, the motion unit 25 is supported at one position on the front frame 40, and is supported at two positions on the rear frame 41. However, as a matter of course, the present exemplary embodiment is not limited thereto. Specifically, the number of components of the motion unit 25 that are supported by the front frame 40 is only required to be smaller than the number of components thereof that are supported by the rear frame 41.

Further, the motion unit 25 is coupled to the front frame 40 and the rear frame 41 with the play in the Y-axis direction. With this, even when the front frame 40 or the rear frame 41 is distorted, such distortion is less likely to affect the motion unit 25. With this, while the position of the motion unit 25 with respect to the front frame 40 and the rear frame 41 is defined, distortion of the front frame 40 can be prevented from affecting the motion unit 25. Thus, the medium can be transported as appropriate.

Further, in the present exemplary embodiment, the play is play in a direction in which the front frame 40 is away from the rear frame 41. Thus, distortion of the front frame 40 in a direction in which the front frame 40 is away from the rear frame 41 as illustrated in FIG. 11B is less likely to affect the motion unit 25.

Note that, in the present exemplary embodiment, as described with reference to FIG. 12, play Y1 for allowing the front frame 40 to move the −Y direction with respect to the first sub frame 26 and play Y2 for allowing the front frame 40 to move in the +Y direction with respect to the first sub frame 26 are provided. However, at least the Y1 is only required to be provided.

Further, as described with reference to FIG. 12, the motion unit 25 is coupled to the front frame 40 by the stepped screw 60. The stepped screw 60 has the head portion 60a, the screw portion 60b that is fitted into the screw hole 26a of the motion unit 25, and the cylinder portion 60c that has a larger diameter than the screw portion 60b and is provided between the head portion 60a and the screw portion 60b. The cylinder portion 60c is inserted into the through hole 40e formed in the front frame 40. With this, while the play can be secured, the front frame 40 and the motion unit 25 can easily be coupled to each other. Further, the motion unit 25 can be prevented from falling off from the frame structure body 39.

Note that each of the supported protrusions including the first supported protrusion 55, the second supported protrusion 56, and the third supported protrusion 57 has a length at the largest part in the Y-axis direction that is set longer than the dimension of the play in the Y-axis direction. Thus, even when the play allows the motion unit 25 to move in the Y-axis direction with respect to the front frame 40 and the rear frame 41, the play maintains a state in which the respective supported protrusions described above are appropriately supported by the respective supporting portions.

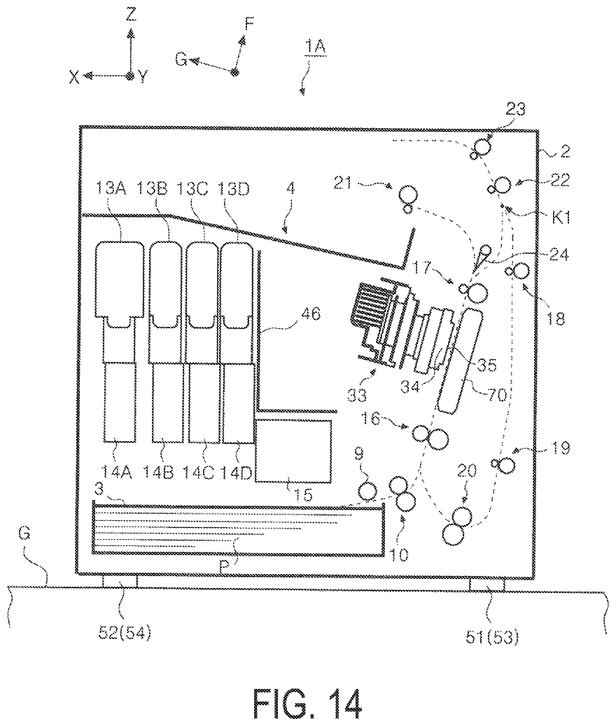

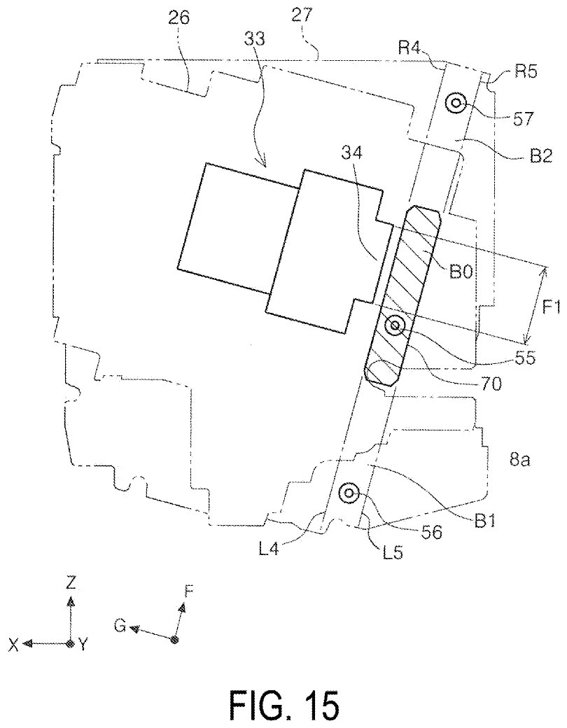

Next, with reference to FIG. 14 and FIG. 15, a recording apparatus according to a second exemplary embodiment is described. A printer 1A according to the second exemplary embodiment illustrated in FIG. 14 and FIG. 15 has a configuration similar to that of the above-mentioned printer 1 according to the first exemplary embodiment, except for a supporting member 70 is included in place of the above-mentioned transport unit 6. Thus, redundant description is omitted.

In FIG. 14, the printer 1A includes the supporting member 70 provided to the position facing the line head 34. The supporting member 70 is a member that defines an interval between the line head 34 and the medium that passes through the position facing the line head 34, and is formed by a resin material, for example.

In FIG. 15, a line L4 is a linear line obtained by extending, toward upstream, a linear line parallel to the F-axis direction passing through the part of the supporting member 70, which is closest to the +G direction, and is indicated with the one-dot chain line. Further, the line L5 is a linear line obtained by extending, toward upstream, a linear line parallel to the F-axis direction passing though the part of the supporting member 70, which is closest to the −G direction, and is indicated with the one-dot chain line.

Further, the line R4 is a linear line obtained by extending, toward downstream, the linear line parallel to the F-axis direction passing through the part of the supporting member 70, which is closest to the +G direction, and is indicated with the one-dot chain line. Further, the line R5 is a linear line obtained by extending, toward downstream, the linear line parallel to the F-axis direction passing though the part of the supporting member 70, which is closest to the −G direction, and is indicated with the one-dot chain line.

The reference symbol B0 is a region of the supporting member 70, in other words, a region surrounded by the outline of the supporting member 70 when the medium transport path is viewed from a side, and is shown by hatching. Further, the reference symbol B1 indicates an upstream extension region obtained by extending the region B0 of the supporting member 70 toward upstream along the F-axis direction. Further, the reference symbol B2 indicates a downstream extension region obtained by extending the region B0 of the supporting member 70 toward downstream along the F-axis direction. The upstream extension region B1 is a region sandwiched between the line L4 and the line L5, and the downstream extension region B2 is a region sandwiched between the line R4 and the line R5. Note that the region B0 of the supporting member 70 is a region in the first sub frame 26, and the upstream extension region B1 and the downstream extension region B2 are regions in the second sub frame 27.

As illustrated, the first supported protrusion 55 being a component of the motion unit 25 that is supported by the front frame 40 is positioned on the inner side of the inner region B0 of the supporting member 70 when the transport path of the medium is viewed from a side. The second supported protrusion 56 being a component of the motion unit 25 that is supported by the rear frame 41 is positioned on the inner side of the upstream extension region B1 when the transport path of the medium is viewed from a side. Further, the third supported protrusion 57 being a component of the motion unit 25 that is supported by the rear frame 41 is positioned on the inner side of the downstream extension region B2 when the transport path of the medium is viewed from a side.

With this, similarly to the first exemplary embodiment described above, the second supported protrusion 56 and the third supported protrusion 57 are arranged so as to sandwich the first supported protrusion 55 therebetween. Thus, when the first supported protrusion 55 is displaced downward due to distortion of the front frame 40, twist of the motion unit 25 can be suppressed.

Further, the first supported protrusion 55, the second supported protrusion 56, and the third supported protrusion 57 are arranged at the positions close to the supporting member 70. Thus, when distortion occurs in the motion unit 25, position deviation of the supporting member 70 from the front frame 40 and the rear frame 41 and posture fluctuation can be suppressed.

With this, even when the front frame 40 is distorted, the medium can be transported as appropriate.

The present disclosure is not limited to each of the exemplary embodiments described above, and many variations can be made within the scope of the present disclosure as described in the claims. It goes without saying that such variations also fall within the scope of the present disclosure.

What is claimed is:

1. A recording apparatus, comprising:
a recording unit including a recorder configured to perform recording on a medium; and
a first side plate and a second side plate being a pair of side plates positioned across the recording unit, and configured to support the recording unit, wherein
an apparatus gravity center position is on a side close to the second side plate with respect to an intermediate position between the first side plate and the second side plate,
the number of components, of the recording unit, supported by the first side plate is smaller than the number of components, of the recording unit, supported by the second side plate,
the recording unit includes a transport belt being a belt arranged at a position facing the recorder, and transports the medium,
the transport belt is stretched around a first pulley and a second pulley that are arranged along a transport direction of the medium,
the components, of the recording unit, supported by the first side plate are positioned on an inner side of the transport belt when a transport path of the medium is viewed from a side, and
the components, of the recording unit, supported by the second side plate are positioned on an inner side of an upstream extension region and an inner side of a downstream extension region when the transport path of the medium is viewed from a side, the upstream extension region being obtained by extending an inner region of the transport belt toward upstream of the transport path, the downstream extension region being obtained by extending the inner region of the transport belt toward downstream of the transport path.

2. A recording apparatus, comprising:
a recording unit including a recorder configured to perform recording on a medium; and
a first side plate and a second side plate being a pair of side plates positioned across the recording unit, and configured to support the recording unit, wherein
an apparatus gravity center position is on a side close to the second side plate with respect to an intermediate position between the first side plate and the second side plate,
the number of components, of the recording unit, supported by the first side plate is smaller than the number of components, of the recording unit, supported by the second side plate,
the recording unit includes a supporting member being a member arranged at a position facing the recorder to support the medium,
the components, of the recording unit, supported by the first side plate overlap the supporting member when a transport path of the medium is viewed from a side, and
the components, of the recording unit, supported by the second side plate are positioned on an inner side of an upstream extension region and an inner side of a downstream extension region when the transport path of the medium is viewed from a side, the upstream extension region being obtained by extending a region of the supporting member toward upstream of the transport path, the downstream extension region being obtained by extending the region of the supporting member toward downstream of the transport path.

3. The recording apparatus according to claim 1, wherein
the recording unit is supported at one position being a first supported portion at the first side plate, and is supported at two positions being a second supported portion and a third supported portion at the second side plate, and
when the transport path of the medium is viewed from a side, the second supported portion is positioned on the inner side of the upstream extension region, and the third supported portion is positioned on the inner side of the downstream extension region.

4. The recording apparatus according to claim 1, wherein
the recording unit is supported at one position being a first supported portion at the first side plate, and is supported at two positions being a second supported portion and a third supported portion at the second side plate,
when the transport path of the medium is viewed from a side, the second supported portion is positioned on the inner side of the upstream extension region, and the third supported portion is positioned on the inner side of the downstream extension region,
when the transport path of the medium is viewed from a side, the first supported portion is positioned on a linear line coupling a rotation center of the first pulley and a rotation center of the second pulley,
when the transport path of the medium is viewed from a side, the second supported portion is positioned on a linear line obtained by extending, toward upstream of the transport path, the linear line coupling the rotation center of the first pulley and the rotation center of the second pulley, and
when the transport path of the medium is viewed from a side, the third supported portion is positioned on a linear line obtained by extending, toward downstream of the transport path, the linear line coupling the rotation center of the first pulley and the rotation center of the second pulley.

5. The recording apparatus according to claim 3, wherein
the first supported portion is located within a region of the recorder in the transport direction of the medium.

6. The recording apparatus according to claim 3, wherein
the recording unit includes
a first sub frame being a frame facing the first side plate and including the first supported portion, and
a second sub frame being a frame facing the second side plate and including the second supported portion and the third supported portion.

7. The recording apparatus according to claim 6, wherein
the first supported portion is formed as a first supported protrusion that is fitted into a first supporting hole formed at the first side plate,
the second supported portion is formed as a second supported protrusion that is fitted into a second supporting hole formed at the second side plate,
the third supported portion is formed as a third supported protrusion that is fitted into a third supporting hole formed at the second side plate, and
when the third supported protrusion and the third supporting hole are fitted, a larger gap is secured than when the second supported protrusion and the second supporting hole are fitted.

8. The recording apparatus according to claim 7, wherein
the second side plate has a through hole through which the recording unit passes, and
when the recording unit moves toward the first side plate through the through hole, the first supported protrusion enters the first supporting hole, the second supported protrusion enters the second supporting hole, and the third supported protrusion enters the third supporting hole.

9. The recording apparatus according to claim 8, wherein
the first side plate and the second side plate are coupled to each other via a coupling member, and
when the recording unit moves toward the first side plate through the through hole, the coupling member supports the recording unit and guides the recording unit toward the first side plate.

10. The recording apparatus according to claim 9, wherein
the recorder includes
a liquid ejection head configured to eject a liquid onto a medium, and
a liquid storage located between the first side plate and the second side plate and configured to store the liquid ejected from the liquid ejection head, and
the coupling member separates, between the first side plate and the second side plate, an arrangement region of the liquid storage and an arrangement region of the recorder from each other.

11. The recording apparatus according to claim 1, wherein
the recording unit is coupled to the first side plate with play,
the play is play at least in a direction in which the first side plate is away from the second side plate,
the recording unit is coupled to the first side plate by a stepped screw,
the stepped screw includes
a head portion,
a screw portion fitted into a screw hole of the recording unit, and
a cylinder portion having a diameter larger than the screw portion and provided between the head portion and the screw portion, and
the cylinder portion is inserted into a through hole formed at the first side plate.

12. The recording apparatus according to claim 1, wherein
a leg portion is provided at each of four corners of a bottom portion of an apparatus main body.
